(19) United States
(12) Patent Application Publication
(10) Pub. No.: US 2014/0128149 A1
(43) Pub. Date: May 8, 2014

(54) Method for Providing a Fantasy Sports-based Competition Website

(71) Applicants: Brent Michael Suyat, Bellevue, WA (US); Theodore Hans Kuoppamaki, Seattle, WA (US)

(72) Inventors: Brent Michael Suyat, Bellevue, WA (US); Theodore Hans Kuoppamaki, Seattle, WA (US)

(21) Appl. No.: 14/073,819

(22) Filed: Nov. 6, 2013

Related U.S. Application Data
(60) Provisional application No. 61/722,831, filed on Nov. 6, 2012.

(51) Int. Cl. A63F 13/12

(52) U.S. Cl. CPC A63F 13/12
USPC 463/25

(57) ABSTRACT

Fantasy sports-based competition website where users pit their sports knowledge against other users for the opportunity to win cash prizes. Contestants utilize their knowledge of the situational elements of the sporting events involved, to predict the winners for each statistical category listed. Contestants apply their analysis for accumulated statistics and pick winners in each category from an identical fantasy roster presented to multiple contestants. In the event of a tie, there is a tiebreaker question where the contestants are asked to make a projection for a total accumulated statistic for all athletes combined. This results in a clear winner for each contest, so the contestant that comes closest to the actual value will be declared the winners. All contestants can challenge each other, or can be paired randomly with each other and the picks of the competing users are not revealed prior to all users having entered their picks.

### CROSS REFERENCE TO RELATED APPLICATIONS

This application claims priority from U.S. patent application Ser. No. 61/722,831, entitled “Method for Providing a Fantasy Sports-based Competition Website”, filed on 6Nov. 2012. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a method for playing a fantasy sports game based upon live sporting events. More specifically, the present invention relates to a method of setting up and presenting teams of actual sports players and basing each team's successes upon the results of actual sports games.

### BACKGROUND OF THE INVENTION

Fantasy Sports has grown in popularity and has millions of fans. It has become common for fans and analysts to score the performance of players and teams, game after game and season after season. Fans frequently organize formal and informal pools to capitalize on their own knowledge of the game and their desire to compete with other fans. These pools and games have become more complex and have moved from paper to computers with the development of the Internet. As a result, numerous online Fantasy Sports games have been devised to mimic various aspects of professional sports. However, the present invention provides a more unique game experience that takes some element of chance away that is inherently present in the games currently offered in the prior art.

### SUMMARY OF THE INVENTION

The present invention is a proposed fantasy sports-based competition website where users pit their sports knowledge against other users for the opportunity to win cash prizes. The present invention provides a more unique game experience that takes some element of chance away that is inherently present in the games offered by traditional fantasy sports sites.

The present invention focuses more on the actual statistics of predetermined rosters. In typical fantasy sports games that involve drafts, there is an element of chance involved in determining the draft order of participants. The participants that get to draft first (or before other participants in the league), can have a distinct advantage over those that pick last. The order in which league participants draft is typically determined in a random manner.

The games offered by the present invention seek to remove that element of chance by providing identical rosters for a contest, whereby users are forced to apply their knowledge of situational elements for each sporting event involved to determine statistical outcomes of the rosters that are provided. This provides an equal starting point for the participants, thereby making their skill at assessing the situational elements of the games the primary determinant of the winner of the competitions.

Each participant in the contest will utilize their knowledge of the situational elements of the sporting events involved, to predict the winners for each statistical category listed. Similarly, contest participants would apply their analysis for accumulated statistics and pick a roster to win in each category. In the event of a tie (e.g. two or more contestants make identical picks), there is a tiebreaker question where the contestants are asked to make a projection for a total accumulated statistic that is predefined. This is designed to make it so there is a clear winner for each contest, so the contestant that comes closest to the actual value will be declared the winners. Contestants can challenge each other, or can be paired randomly with each other, and the picks of the competing users are not shown to contestants until after all picks have been made and finalized.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a basic question presented to a contestant using the fantasy sports game method of the present invention;

FIG. 2 is a screen shot of the game editor taught and used by the method of the present invention by a game creator to set up a fantasy sports game;

FIG. 3 is a screen shot of a published game created by the method of the present invention;

FIGS. 4-5 are a screen shots of the entering process of a contestant participating in a game created and executed by the game method taught by the present invention;

FIG. 6 is a screen shot of the completed game flow entry of a contestant participating in one game offered by the method of the present invention;

FIG. 7 is a screen shot of the game editor taught and used by the method of the present invention by a game creator to set up a stock market game;

FIG. 8 is a screen shots of the entering process of a contestant participating in a stock market game created and executed by the game method taught by the present invention; and

FIG. 9 is a screen shots of the entering process of a contestant participating in a multi-sport game created and executed by the game method taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The present invention is a proposed fantasy sports-based competition website where users pit their sports knowledge against other users for the opportunity to win cash prizes. The site is similar to daily fantasy sports known in the prior art, in that the games are played daily and where winners are determined by accumulated statistical results of sporting events. However, to differentiate from those sites, the present invention intends to provide a more unique game experience that takes some element of chance away that is inherently present in the games offered by the sites above.

While the daily fantasy sports websites known in the prior art as well as traditional season-long Fantasy Sports leagues focus on the building of a roster that will achieve maximum fantasy point values, the present invention focuses more on the actual statistics of predetermined rosters.

In typical fantasy sports games that involve drafts, there is an element of chance involved in determining the draft order of participants. The participants that get to draft first (or before other participants in the league), can have a distinct advantage over those that pick last. The order in which league participants draft is typically determined in a random manner.

The games offered by the present invention seek to remove that element of chance by providing identical rosters for a contest, whereby users are forced to apply their knowledge of situational elements for each sporting event involved to predict statistical outcomes of the rosters that are provided. This provides an equal starting point for the participants, thereby making their skill at assessing the situational elements of the games the primary determinant of the winner of the competitions.

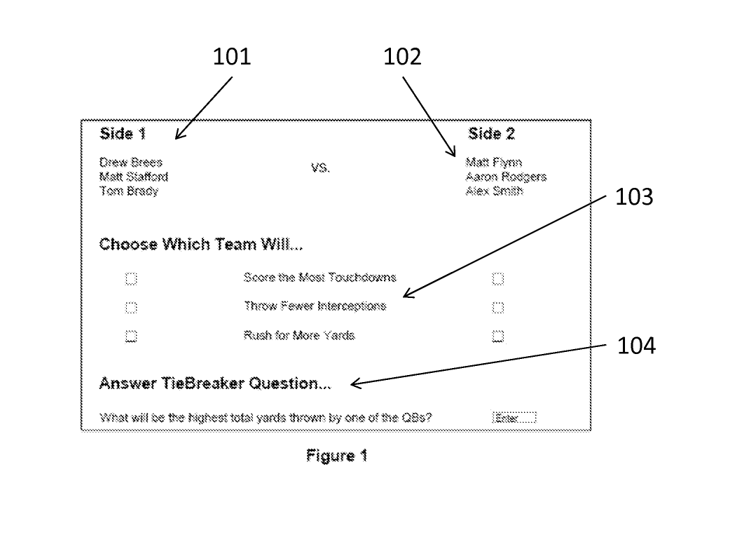

To describe these situational elements, the following example game and competition is one that might be offered by the present invention. Now referring to FIG. 1, users are first presented with two competing fantasy football rosters 101 and 102 and then asked a series of questions 103, asking them to predict which roster will “win” in specific accumulated statistical categories. Each participant in the contest will utilize their knowledge of the situational elements of the sporting events involved, to predict the winners for each statistical category listed. These situational elements can include factors such as: An athlete's historical performance against the specific team they are facing; An athlete's performance where weather conditions may play a factor (e.g. domed stadium, December game in Green Bay Wis., September day in Phoenix Ariz.); An athlete's performance against specific types of NFL defenses (e.g. a 3-4 defense versus a 4-3 defense); or any intangible factors that might factor into the games being played (e.g. playoff spot on the line, or not on the line, nagging injuries).

In the above example, consider a contestant who may have concluded, after their own analysis of the situational elements, that the team of Matt Flynn, Aaron Rodgers, and Alex Smith 102 will combine to pass for 10 total touchdowns, while also concluding that the team of Drew Brees, Matt Stafford, and Tom Brady 101 will combine to throw only 7 touchdown passes. Therefore, the contestant would select the former team 102 to win in that specific statistical category as shown in FIG. 1.

Similarly, contest participants would apply their analysis for each additional accumulated statistic and pick a roster to win in each category. In the event of a tie (e.g. 2 or more contestants make identical picks), there is a tiebreaker question 104 where the contestants are asked to make a projection for a total accumulated statistic that is predefined. This is designed to make it so there is a clear winner for each contest, so the contestant that comes closest to the actual value will be declared the winners.

All Contestants can challenge each other, or can be paired randomly with each other and the picks of the competing users are not shown to contestants until after all picks have been made and finalized.

Any and all games offered by the present invention will adhere to the UIGEA requirements to qualify as Fantasy Sports games. This means all games will involve more than two teams, with more than two athletes, and include more than one sporting venue or event. In addition, all prizes will be known up-front to the participants, at the time of contest entry.

The present invention is a unique and compelling fantasy sports based offering that eliminates some elements of chance that are inherent in the fantasy sports leagues that are offered today and known in the prior art. The fantasy-based games taught by the present invention are more in line with the intent of the current federal and state gaming laws, which have been enacted with the intent to make the games skill-based as opposed to chance-based. By forcing players to begin at an identical starting point and use their knowledge and analytical skills to successfully compete against others, the present invention teaches a method of fantasy sports gaming that is more focused on contestant skill than chance.

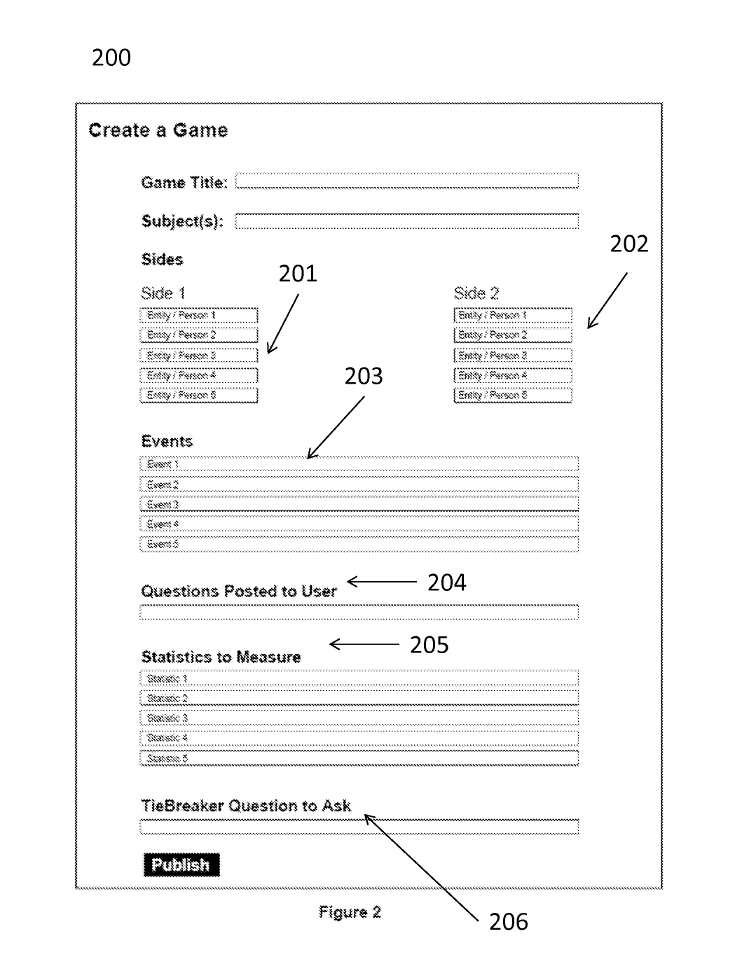

Now referring to FIG. 2, the game flow 200 of the present invention is illustrated. A game is created via a website running on a computer and displayed to a user through a computer or equivalent device. Using an administration tool, creator enters athletes or other entities for which certain performances are measured and published 205 and poses questions 204 to the users to answer which side/roster will “win: each statistic that is measured 205. To provide the most compelling and challenging game, the creator attempts to put equally weighted athletes in two or more rosters 201 and 202. The creator then chooses which performances 203 those athletes will be measured. The creator writes a tiebreaker question 204, used in the situation where players choose the same athletes and performance measures. The creator enters game dollar amounts and game types (2 player, 3 player, 4 player, etc.). The creator publishes the game to system website for viewing and playing by contestants.

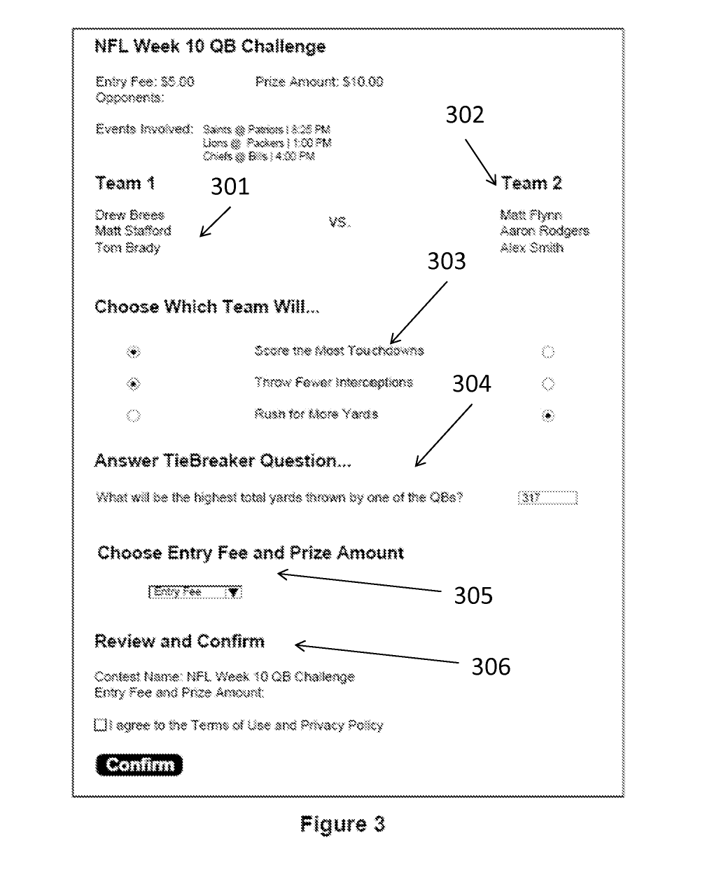

Now referring to FIG. 3, users are presented with two or more teams of athletes 301 and 302, and tasked with determining which team will prevail in the performance measures presented 303. Users are given the events, teams and sports involved; parameters allowing them to determine whether they think their knowledge will allow them to successfully compete in the game. User answer a tiebreaker question 304, select an entry and prize amount 305 and review and confirm their picks before submission 306.

Users may choose to research the athletes involved: is anyone hurting, can they throw/run in the rain, are they competing against better athletes, etc.? Users may choose to also research the events involved: is it cold/hot/rainy at these events, does the time of day matter, is there a big home field advantage? Or, users may be immediately confident of their choices and enter the game without researching. Playing the game can be quick and easy, allowing for casual and extreme sports fans to get involved in fantasy sports. Additionally, these sports fans are given clear parameters upon which they can focus their research to better compete.

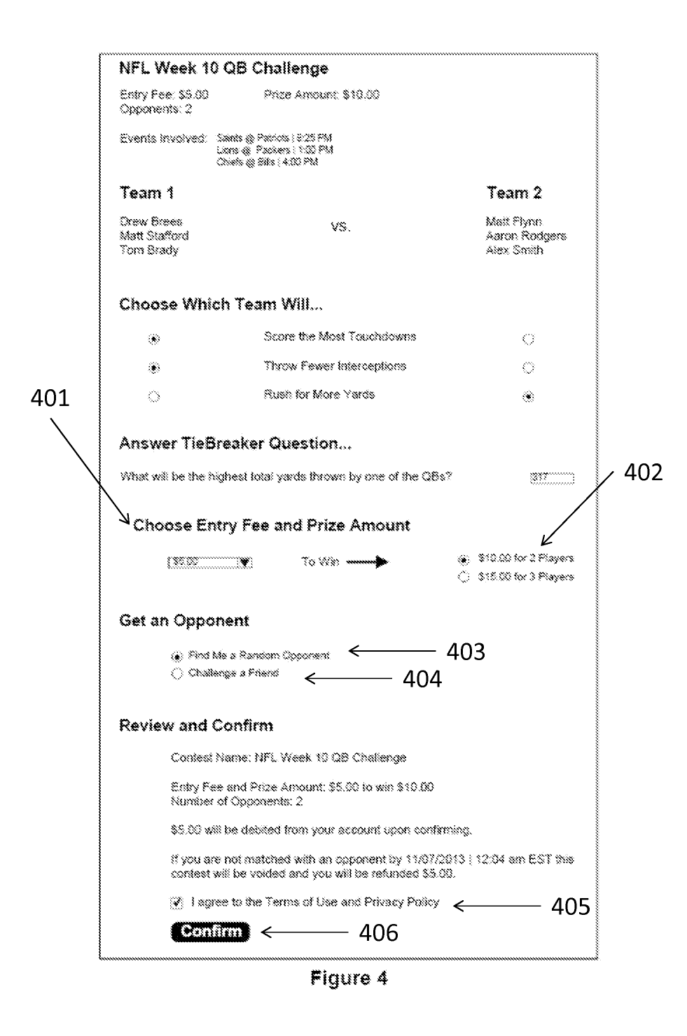

As shown in FIG. 4, after a user has chosen which roster of athletes they think will prevail in each performance measure presented (and answered the tiebreaker question), they: Choose the entry fee amount 401; Choose the numbers of players to compete against 402; can Challenge a friend (or accept a challenge) 403; or Challenge a random opponent 404; Agree to terms 405; and Enter/confirm 406.

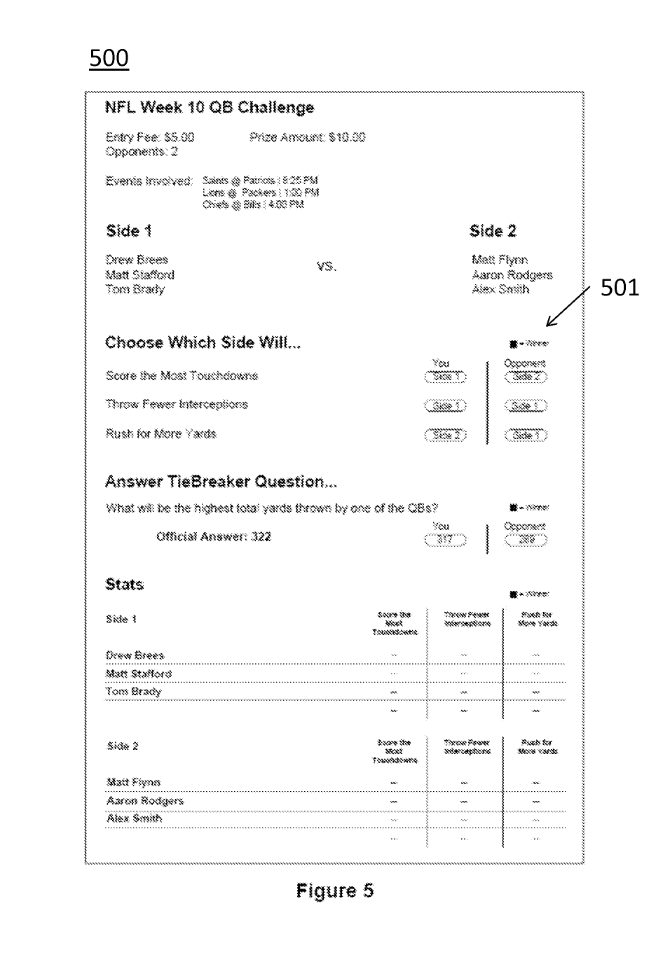

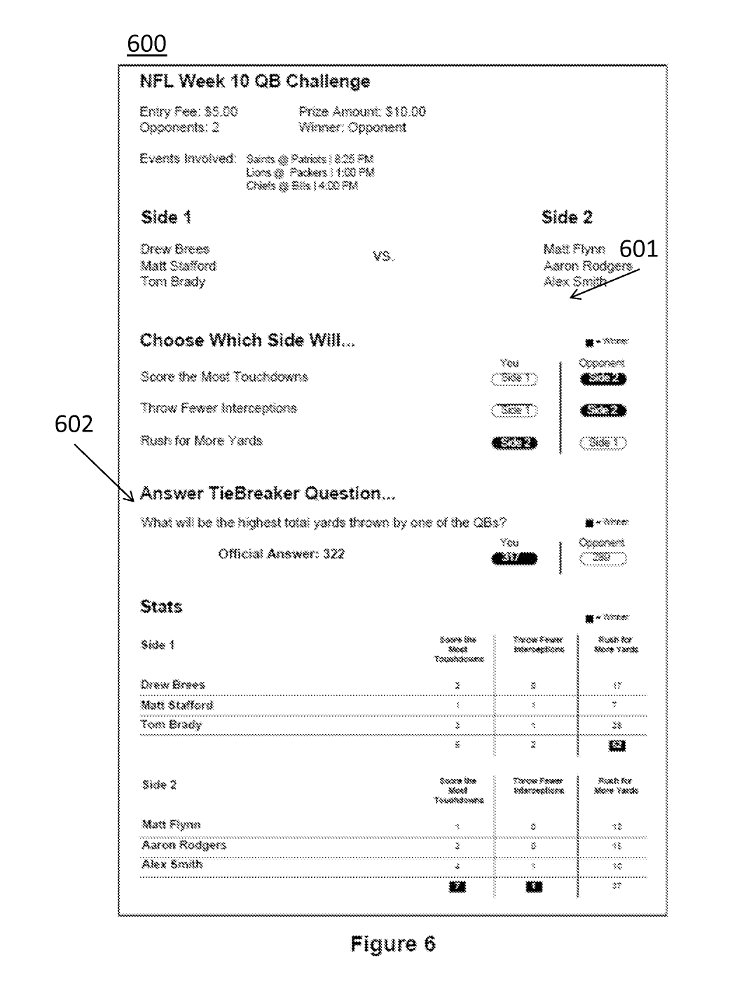

After successfully entering, users are provided a confirmation 500 of their selections. After all contestants have successfully entered a game, the selections of their opponents are revealed 501. Users are provided a confirmation and shown their choices, and their opponent's choices when matched as shown in FIG. 5. When sporting events involved have ended and the official performance measures have been published by appropriate governing body (NFL, MLB, NBA, etc.), the users involved in the game are notified whether they won or lost. Users can view the completed game on the website 600 as shown in FIG. 6. On the website, users will see the statistics for each performance measure of the athletes involved 601, as well as the answer to the tiebreaker question 602.

The method taught by the present invention is set to run on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention. The method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

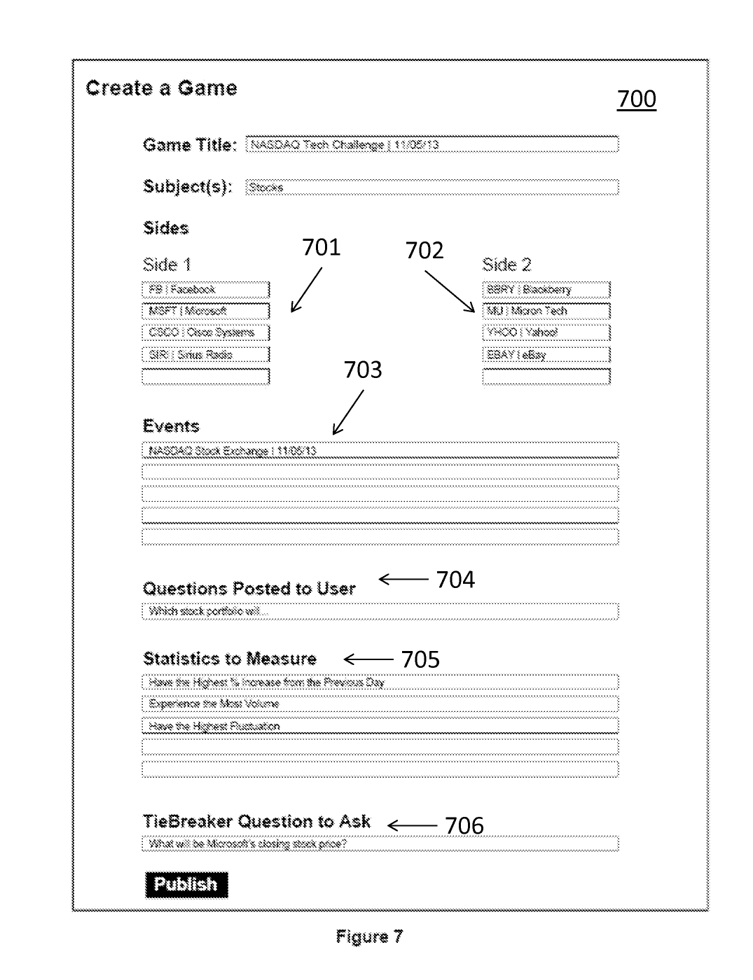

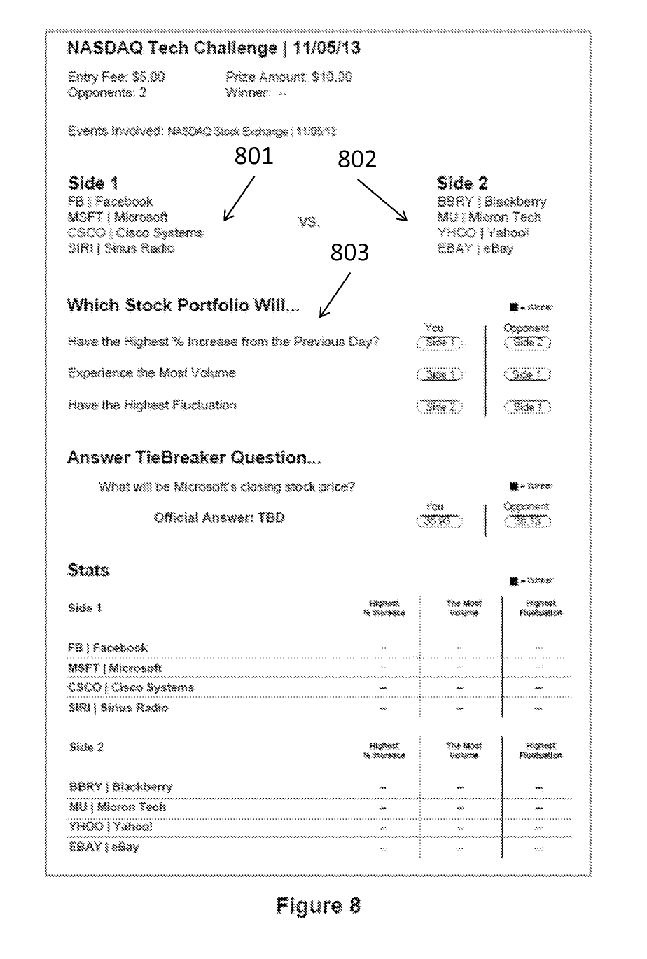

In another embodiment of the invention shown in FIGS. 7-8, the method of the present invention can be used to create a fantasy stock portfolio game 700. The same method taught and used by the present invention for a fantasy sports game is used, stock performances and portfolios, which are measured and published are used instead of an athlete's performance. In this embodiment single rosters 701 and 702 are comprised of one or more stocks, mutual funds, stock portfolios or other financial instruments from a plurality of different markets.

A game is created via a website running on a computer and displayed to a user through a computer or equivalent device. Using an administration tool, a creator enters one or more stocks, mutual funds, stock portfolios or other financial instruments for which certain performances are measured and published. To provide the most compelling and challenging game, the creator attempts to put equally weighted one or more stocks, mutual funds, stock portfolios or other financial instruments in two or more rosters. The creator then chooses which performances/events 703 of those one or more stocks, mutual funds, stock portfolios or other financial instruments will be measured 705 and presents them to uses in the form of questions 704. The creator writes a tiebreaker question 706, used in the situation where players choose the same stocks, mutual funds, stock portfolios or other financial instruments and performance measures. The creator enters game dollar amounts and game types (2 player, 3 player, 4 player, etc.). The creator publishes the game to system website for viewing and playing by contestants.

Users are presented with two or more teams 801 and 802 of one or more stocks, mutual funds, stock portfolios or other financial instruments and tasked with determining which team will prevail in the performance measures presented. Users are given performance measures 803 on which each one or more stocks, mutual funds, stock portfolios or other financial instruments are being measured and parameters of the contest allowing them to determine whether they think their knowledge will allow them to successfully compete in the game.

Users may choose to research the one or more stocks, mutual funds, stock portfolios or other financial instruments involved or to also research the events involved. Or, users may be immediately confident of their choices and enter the game without researching. Playing the game can be quick and easy, allowing for casual and extreme stock market followers to get involved in fantasy competition, investing, or similar financial interests. Additionally, the contestants are given clear parameters upon which they can focus their research to better compete which reduces the probability of chance being a factor in the outcome of the contest.

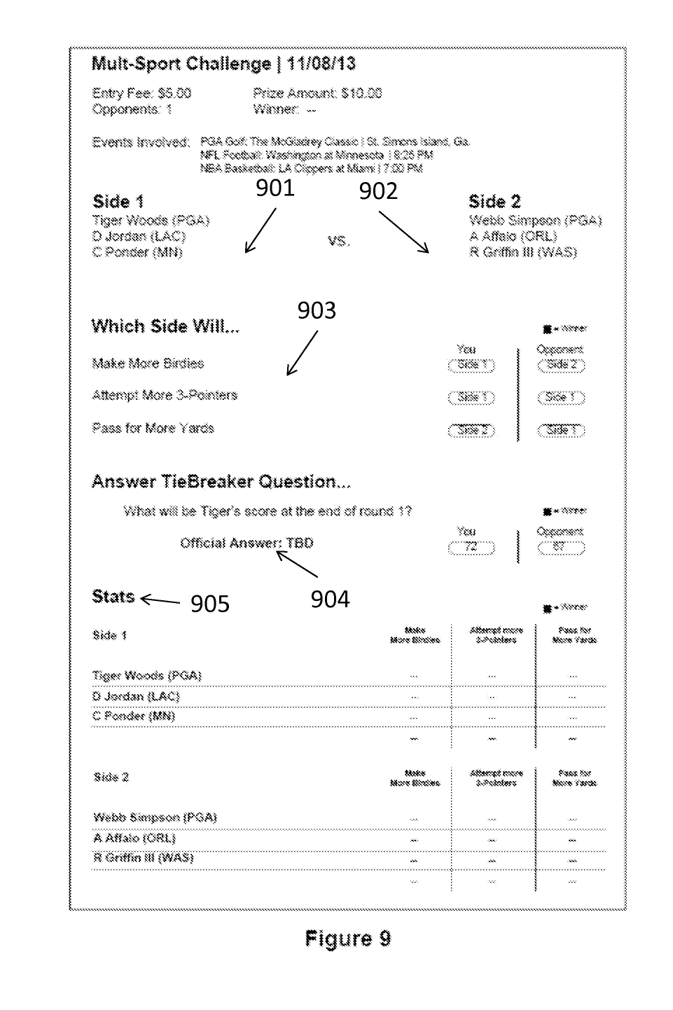

In yet another embodiment shown in FIG. 9, the method of the present invention can be used to create multi-sport fantasy games. In this embodiment single rosters 901 and 902 are comprised of two or more athletes from a plurality of different sports. A game is created via a website running on a computer and displayed to a user through a computer or equivalent device. Using an administration tool, a creator enters athletes or other entities for which certain performances are measured and published. To provide the most compelling and challenging game, the creator attempts to put equally weighted athletes in two or more rosters. The creator then chooses which performances those athletes will be measured 903. The creator writes a tiebreaker question 904, used in the situation where players choose the same athletes and performance measures. The creator enters game dollar amounts and game types (2 player, 3 player, 4 player, etc.). The creator publishes the game to system website for viewing and playing by contestants.

In this embodiment, the athletes selected are not from a single sport, but can be from any a plurality of different sports as long as certain aspects of their performances are measured and published 905. This results in a game that is not sport specific and may be interesting to people who are not singly focused on one sporting type or event.

Users are presented with two or more teams 901 and 902 of two or more athletes which form a plurality of sports, and tasked with determining which team will prevail in the performance measures presented 903. Users are given the events, teams, and sports involved; parameters allowing them to determine whether they think their knowledge will allow them to successfully compete in the game. Users may choose to research the athletes involved and to also research the events involved. Or, users may be immediately confident of their choices and enter the game without researching. Playing the game can be quick and easy, allowing for casual and extreme sports fans to get involved in fantasy sports. Additionally, these sports fans are given clear parameters upon which they can focus their research to better compete which reduces the probably of chance being a factor in the outcome of the contest.

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention. The method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. The present invention can be adopted to any situation where specific performances are measured and published. The performances are not limited to sports or financial markets. The method of the present invention can be used for or adapted to any measureable performance to create the basic contest or game taught by the present invention and embodiment by the examples given and anticipated first applications of the method.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A computer readable medium having computer executable instructions, that when executed by a computer causes the computer to perform a method for playing a fantasy sport, the fantasy sport corresponding to an actual sport in which players have specified positions, the method comprising:
providing a computer system;
providing identical rosters for a contest to one or more contestants;
presenting two or more competing fantasy sports rosters;
asking a series of questions;
asking for a prediction of which roster will win in specific accumulated statistical categories;
applying knowledge of situational elements for each sporting event involved to determine statistical outcomes of the rosters that are provided;
making a skilled assessment of the situational elements of the games the determinant of the winner of the competitions;
recording the winning predictions for each of the categories presented;
presenting a tiebreaker question where the contestants are asked to make a projection for a total accumulated statistic that is predefined;
recording a tiebreaker answer;
pairing contestants;
declaring a winner; and
revealing the contestant's picks.

2. The method of claim 1, wherein contestants are paired via invitation.

3. The method of claim 1, wherein contestants are paired randomly.

4. The method of claim 1, wherein the situational elements include athlete's historical performance against the specific team they are facing;
an athlete's performance where weather conditions may play a factor;
an athlete's performance against specific types of; and
any intangible factors that factor into the games being.

5. The method of claim 1, wherein in the event of a tie, comprising the addition steps of:
presenting a tiebreaker question;
requiring contestants to make a projection for a total accumulated predefined statistic;
determining a clear winner for each contest, whereby the contestant that comes closest to the actual value will be declared the winners.

6. The method of claim 1, wherein all contestants can challenge each other.

7. The method of claim 1, wherein the picks of the competing users are not shown to contestants until after all picks have been made and finalized.

8. The method of claim 1, wherein all games will involve more than two teams, with more than two athletes, and include more than one sporting venue or event.

9. A computer readable medium having computer executable instructions, that when executed by a computer causes the computer to perform a method for playing a fantasy sport, the fantasy sport corresponding to an actual sport in which players have specified positions, the method comprising:
creating a game via a website running on a computer and displayed to a user through a computer or equivalent device;
using an administration tool;
entering athletes or other entities for which certain performances are measured and published;
placing equally weighted athletes in two or more rosters;
choosing which performances of those athletes will be measured;
writing a tiebreaker question, used in the situation where players choose the same athletes and performance measures;
entering game dollar amounts and game types;
publishing the game to a system website for viewing and playing by contestants.

10. The method of claim 9, wherein
users are presented with two or more teams of athletes, and tasked with determining which team will prevail in the performance measures presented; and
users are given the events, teams, and sports involved; parameters allowing them to determine whether they think their knowledge will allow them to successfully compete in the game.

11. The method of claim 9, further comprising the steps of:
selecting the entry fee amount;
selecting the numbers of players to compete against;
challenging a friend or accepting a challenge);
challenging a random opponent;
agreeing to terms; and
entering the game.

12. The method of claim 11, further comprising the steps of:
providing a confirmation of selections;
revealing the selections of opponents after all competitor selections are received;
providing a confirmation;
displaying the selections;
notifying the users involved in the game whether they won or lost.

13. The method of claim 12, further comprising the steps of:
displaying the completed game on the website ;
displaying statistics for each performance measure of the athletes involved, as well as the answer to the tiebreaker question.

14. The method of claim 9, further comprising the steps of:
creating a multi-sport fantasy games;
creating single rosters comprised of two or more athletes from a plurality of different sports;
creating a via a website running on a computer and displayed to a user through a computer or equivalent device;
using an administration tool;
entering athletes or other entities for which certain performances are measured and published;
placing equally weighted athletes in two or more rosters;
choosing which performances those athletes will be measured;
writing a tiebreaker question, used in the situation where players choose the same athletes and performance measures;
entering the game dollar amounts and game types ;
publishing the game to system website for viewing and playing by contestants.

15. A computer readable medium having computer executable instructions, that when executed by a computer causes the computer to perform a method for creating a fantasy stock portfolio, the method comprising:
creating a fantasy stock portfolio game;
measuring and publishing stock performances and portfolios;
single rosters are comprised of one or more stocks, mutual funds, stock portfolios or other financial instruments from a plurality of different markets;
creating a game via a website running on a computer and displayed to a user through a computer or equivalent device;
using an administration tool, entering one or more stocks, mutual funds, stock portfolios or other financial instruments for which certain performances are measured and published;
placing equally weighted one or more stocks, mutual funds, stock portfolios or other financial instruments in two or more rosters;
choosing which performances of those one or more stocks, mutual funds, stock portfolios or other financial instruments will be measured;
writing a tiebreaker question, used in the situation where players choose the same stocks, mutual funds, stock portfolios or other financial instruments and performance measures;
entering game dollar amounts and game types;
publishing the game to system website for viewing and playing by contestants.
presenting users with two or more teams of one or more stocks, mutual funds, stock portfolios or other financial instruments and tasked with determining which team will prevail in the performance measures presented;
providing performance measures on which each one or more stocks, mutual funds, stock portfolios or other financial instruments are being measured and parameters of the contest.
